(19) United States
(12) Patent Application Publication
(10) Pub. No.: US 2008/0273940 A1
(43) Pub. Date: Nov. 6, 2008

(54) Wing-bolt

(76) Inventor: Mark Horowitz, Fort Lauderdale, FL (US)

Correspondence Address: David E. Orr, 4616 NE 134th Street, Vancouver, WA, 98686, US

(21) Appl. No.: 11/799,570

(22) Filed: May 3, 2007

(51) Int. Cl. F16B 35/06; E06B 3/30

(52) U.S. Cl. 411/340; 49/506

(57) ABSTRACT

A wing-bolt for holding panels or covers over openings for protection against intrusions during storms or bad weather.

### FIELD

The present invention relates to hardware, such as bolts, screws and nuts; more specifically the present invention is a wingbolt for securing and holding panels or protective coverings for windows and such, used for storms and hurricanes.

### BACKGROUND

Violent weather is becoming a norm throughout the world. And as the effects of global warming become more pronounced, we can expect even more damage and death. In locales, such as Florida, the Gulf Coast, and “Tornado Alley” (Texas, Kansas, Oklahoma, Arkansas and Missouri) it is quite common to board-up windows and doors to protect homes and business from wind and water damage. Corrugated panels or plywood sheeting with holes located along the perimeter are suspended from threaded rods protruding from an exterior wall above the door or window. Lead inserts are embedded in the wall and are located in a fashion that aligns with the holes in the panels or sheeting. Wing nuts are tightened on the threaded rods at the top and the bottom parts of panels or sheeting are secured with flat head sidewalk screws.

Usually there is a number of different kinds of storm protection for windows and doors on a single building. This can result in a variety of fasteners used to secure the protective devices. Multiple types of fasteners require carrying, keeping track of and using a variety of drill bits or tools, when utilizing multiple types of one fastener type to another. For example, sidewalk screws require either a broad flat head screwdriver or specialized driver to fully tighten. Sidewalk screws require either a large flat head screwdriver or specialized driver to remove since they cannot be fully tightened by hand.

What is needed is a better system and method for securing panels and sheeting for weather protection.

### OBJECTS AND ADVANTAGES

In response to the requirement for securing a window, door or building opening, an invention has been made with several objectives and attendant benefits in mind. Among these are a system and method for securing a door, window or structure against intrusion by wind, rain or flying objects, wherein the system and method can utilize existing facilities, such as a threaded insert that is used with prior art attachment means.

Another object is a system and method for attachment that does not require special tools and can be attached by hand.

And yet another object is a system and method for attachment that is universal.

The benefits and advantages of the invention will appear from the disclosure to follow. In the disclosure reference is made to the accompanying drawing, which forms a part hereof and in which is shown by way of illustration a specific embodiment in which the invention may be practiced. This embodiment will be described in sufficient detail to enable those skilled in the art to practice the invention, and it is to be understood that other embodiments may be utilized and that structural changes may be made in details of the embodiments without departing from the scope of the invention.

### SUMMARY

Therefore, in view of the foregoing, herein is disclosed in an exemplary embodiment, a wing-bolt for securing and holding panels and the like over doors, windows and the like.

### BRIEF DESCRIPTION OF DRAWINGS

### Labeling Convention Used

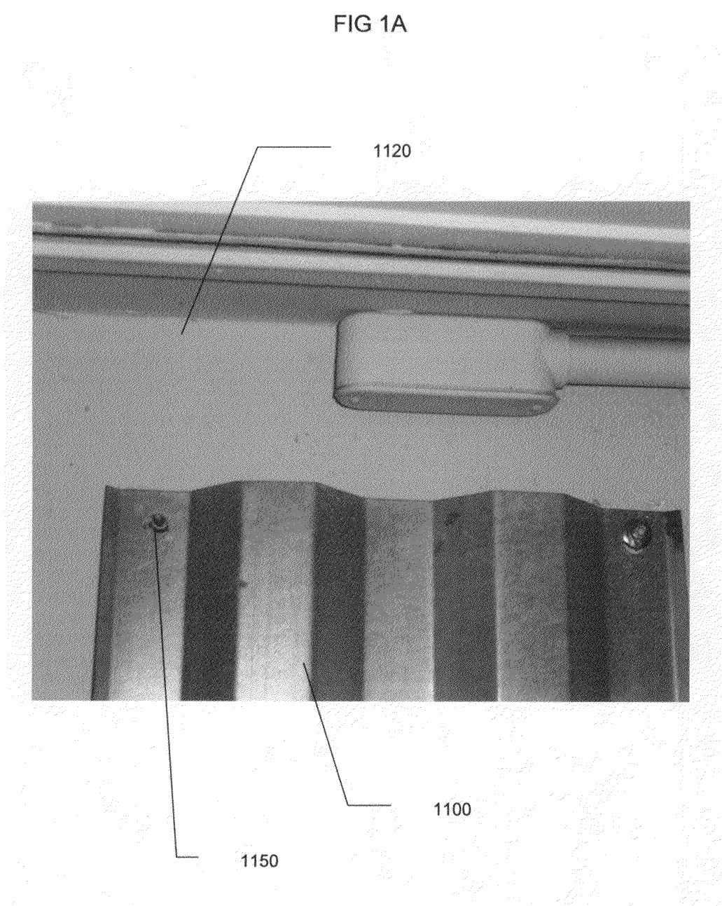

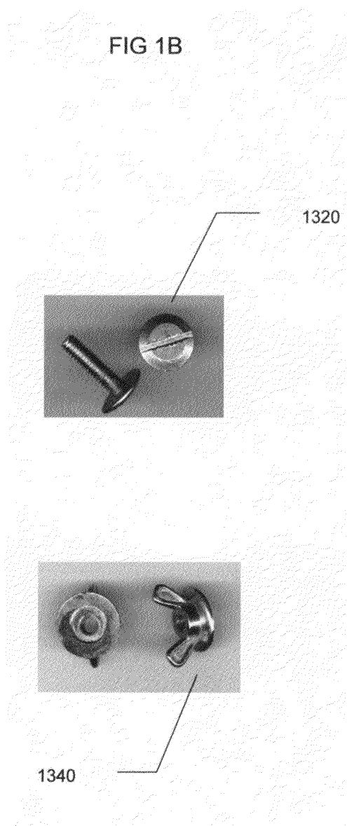

In the drawings, a four digit number is used to designate an element of use for the wing-bolt disclosed herein. The first digit is the number of the figure. For example, components shown in FIG. 1 are designated by “1xxx”, where “xxx” is the number assigned to a component.

The following three digit numbers are assigned to the various components of the preferred embodiment:

020 wall, window, door or structure protected

070 insert having threads

100 plate, shield, cover or the like used for protection

110 hole in plate, shield or cover

150 prior art attachment means, such as a screw, stud or nut

200 wing-bolt

320 prior art device

340 prior art device

FIG. 1A depicts a plate or cover with prior art attachment means.

FIG. 1B shows prior art attachment devices

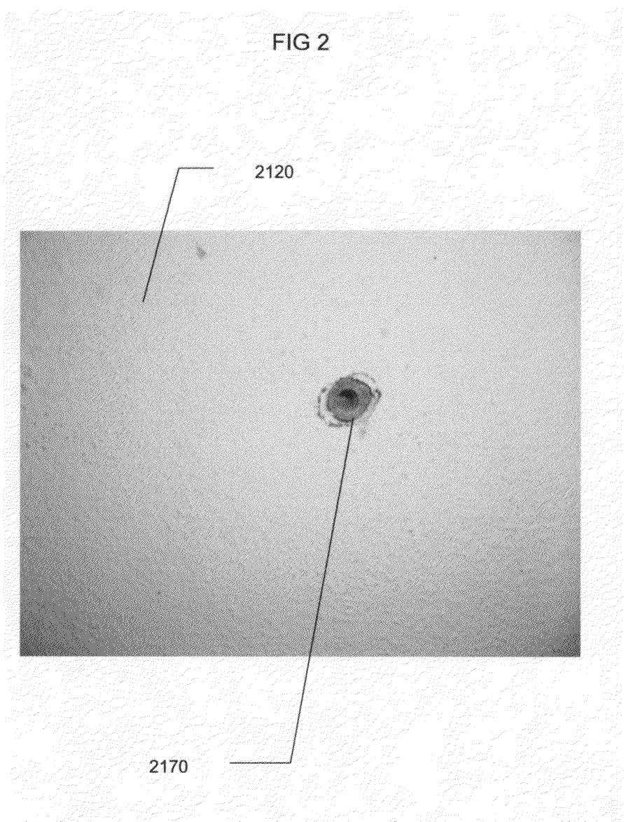

FIG. 2 illustrates a structure having a threaded insert for receiving an attachment means.

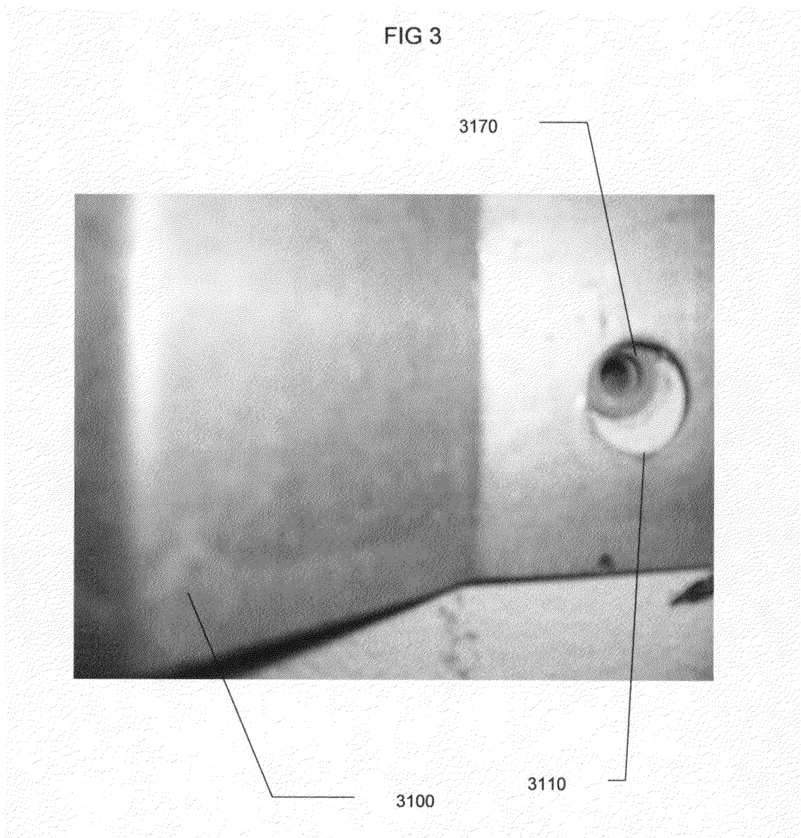

FIG. 3 shows a plate having a hole, the hole aligned with a threaded insert.

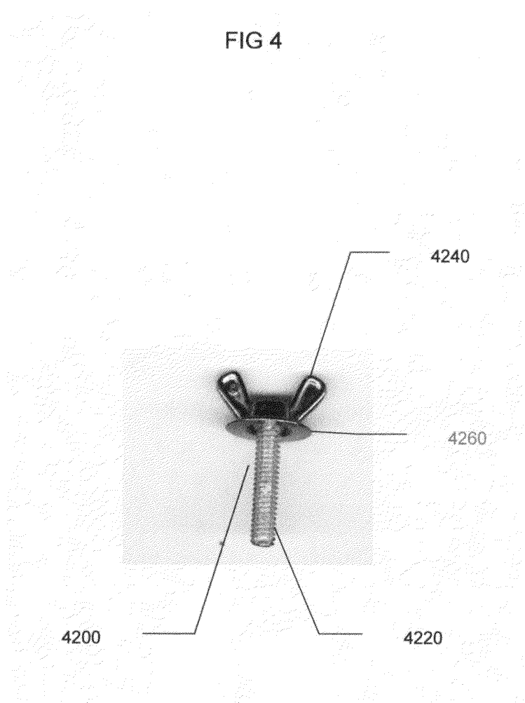

FIG. 4 shows the wing-bolt.

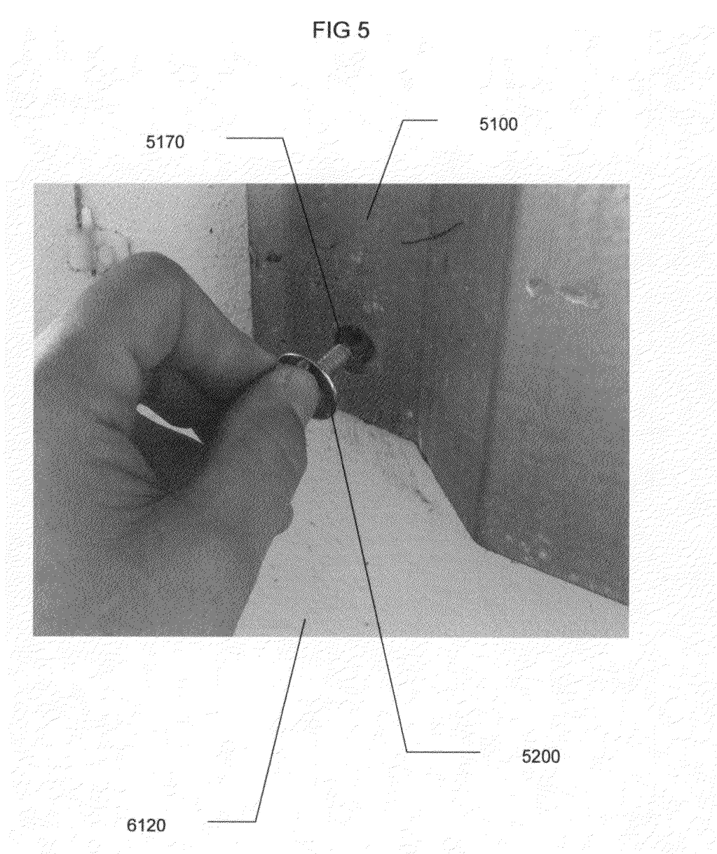

FIG. 5 shows the wing-bolt being attached.

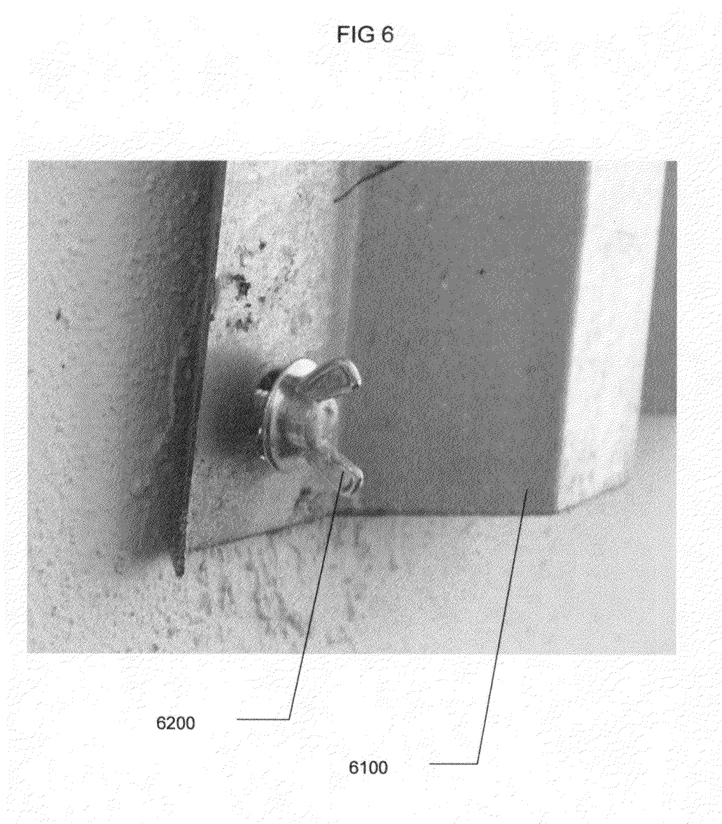

FIG. 6 shows the panel being held in place by the wing-bolt.

### DETAILED DESCRIPTION

FIG. 1A shows a panel 1100 held in place by a prior art attachment means 1150, such as a stud that is attached to a wall 1120, the stud 1150 being threaded with a nut. This illustration exemplifies a standard way of keeping wind, rain, water or detritus from passing through doors, windows or openings.

FIG. 1B shows examples of prior art attachment devices, such as a sidewalk screw 1320 and a wing nut 1340 that attaches to a stud that is embedded in a wall to hold a shield, board or the like.

FIG. 2 shows a wall 2120 having a threaded insert 2170, which accepts a stud or screw, which requires a screwdriver or tool to complete fastening.

FIG. 3 shows a panel 3100 having a hole 3110, which is aligned with the threaded insert 3170.

### Exemplary Embodiment

With reference to FIG. 4, an exemplary embodiment of the wing-bolt 4200 is shown wherein the wing-bolt 4200 comprises a threaded portion 4220, which is accepted by the threaded insert 3170 of FIG. 3. The wing-bolt 4200 also has a plurality of wings 4240, which are grasped and used to turn and tighten or loosen the wing-bolt 4240. The wing bolt 4200 also has an integrated washer 4260, which is cast or machined as part of the device 4200.

FIG. 5 shows the wing-bolt 5200 being inserted and screwed into the threaded insert 5170 to hold in place a panel 5100.

FIG. 6 shows the wing-bolt 6200 installed to hold the panel 6100.

### DISCLOSURE SUMMARY

A single exemplary embodiment of a novel wing-bolt has been disclosed. In view of this disclosure other embodiments will be discerned. The exemplary embodiment and others that may be derived therefrom are most suitably delineated by the claims that accompany this disclosure.

I claim:

1. A fastener for fastening a cover over an opening in a structure to prevent water, debris or wind intrusion, the fastener received by a threaded insert in the structure, wherein the fastener comprises a wing for grasping and turning and a threaded body received by the insert, whereby the fastener is passed through a hole in the cover, and is threaded into the insert by turning the wing.

2. A fastener for attaching a cover over an opening in a structure, the fastener passing through a hole in the cover and received and held by a threaded insert in the structure, wherein the fastener comprises a threaded length for threading into the insert and is terminated by a flared head for turning.

3. A method for covering an opening in a structure to prevent intrusion by water, wind or debris, the method comprising:
providing the fastener of claim 3;
providing the cover, the cover having a hole of sufficient size to accept the fastener;
providing an insert configured to receive the fastener; the insert provided in the structure;
placing the cover over the opening, the cover aligned so the hole in the cover is aligned with the insert, and;
inserting the fastener through the hole and screwing the fastener into the insert, whereby the cover is held over the opening and prevents said intrusion.
